(19) United States
(12) Patent Application Publication
(10) Pub. No.: US 2013/0340303 A1
(43) Pub. Date: Dec. 26, 2013

(54) CARPET BOARD ASSEMBLY

(71) Applicant: Michael Lamendella, Chicago, IL (US)

(72) Inventor: Michael Lamendella, Chicago, IL (US)

(21) Appl. No.: 13/533,393

(22) Filed: Jun. 26, 2012

(51) Int. Cl. G09F 5/00; G09F 5/04

(52) U.S. Cl. 40/1

(57) ABSTRACT

A portable assembly for shop-at-home services includes a rigid substrate with a plurality of flooring samples of the same style removably arranged on the rigid substrate. The rigid substrate includes an upper left corner and a lower right corner. The plurality of flooring samples are positioned to create a visible impression that the flooring samples are permanently attached to the rigid substrate. The portable assembly includes a plurality of indicia, a respective one adjacent each of the samples and indicating a price for the respective sample. The prices are arranged in descending order from the upper left corner to the lower right corner. The plurality of indicia are permanently attached to the rigid substrate, such that the price of the sample located in the upper left corner is the highest and the price of the sample located in the lower right corner is the lowest.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to shop-at-home catalogs, and more particularly, to shop-at-home catalogs of flooring samples that provide upfront pricing.

### BACKGROUND OF THE INVENTION

Shop-at-home catalogs, such as catalogs of carpet samples, tile samples and the like, have been used for many years. Generally, companies send a customer representative to a customer home after receiving a request by the customer. The customer representative brings a catalog containing a variety of flooring samples, such as carpet samples, as requested by the customer. Such catalogs do not display pricing for such samples. On the contrary, companies keep pricing secret, such that the price to an individual customer is determined after or during a first home visit. The method of calculating the price is not disclosed to the customer; moreover, the price for the same flooring generally differs from customer to customer. Additionally, the selection may differ from customer to customer, such that certain customers are shown only the more expensive flooring options based on a variety of factors, including demographics. Thus, customers have no assurance that the price of the goods they are purchasing actually reflects the quality of the goods or that the price they are being offered is the same price that is offered to other customers.

In the shop-at-home industry, there is an unfulfilled need to provide a wide selection of samples and upfront pricing for such samples, such that the pricing does not differ from customer to customer. Customers need assurance that they are provided with honest and reasonable pricing that reflects the quality of the goods they are purchasing. These and other unfulfilled needs are addressed by the present disclosure.

### SUMMARY OF THE INVENTION

Some aspects disclosed herein relate to a portable assembly for shop-at-home services including a rigid substrate with a plurality of flooring samples removably arranged or affixed thereon. The rigid substrate includes an upper left corner and a lower right corner. The plurality of flooring samples are positioned to create a visible impression that the flooring samples are permanently attached to the rigid substrate. The portable assembly includes a plurality of indicia, a respective one adjacent each of the samples and indicating a price for the respective sample. The prices are arranged in descending order from the upper left corner to the lower right corner. The plurality of indicia are permanently attached to the rigid substrate, such that the price of the sample located in the upper left corner is the highest and the price of the sample located in the lower right corner is the lowest.

Another aspect disclosed herein relates to a portable assembly for shop-at-home services including two or more rigid substrates arranged in a folder. Each one of the two or more rigid substrates includes an upper left corner and a lower right corner. A plurality of flooring samples of one style are removably arranged on each one of the two or more rigid substrates and are positioned to create a visible impression that the flooring samples are permanently attached to each one of the two or more rigid substrates. Each one of the two or more rigid substrates includes a plurality of indicia positioned a respective one adjacent each of the samples and indicating a price for the respective sample. The prices are arranged in descending order from the upper left corner to the lower right corner, the plurality of indicia being permanently attached to each one of the two or more rigid substrates, such that the price of the sample located in the upper left corner is the highest out of the plurality of indicia and the price of the sample located in the lower right corner is the lowest out of the plurality of indicia. The indicia are configured to provide assurance to a shop-at-home customer that the price associated with each of the samples is the actual price of the samples and does not vary from one shop-at-home customer to another.

Yet another aspect disclosed herein relates to a portable assembly for shop-at-home services including a rigid substrate. The rigid substrate includes an upper left corner and a lower right corner. A plurality of flooring samples of the same style are arranged on the rigid substrate and are permanently attached thereto. The portable assembly includes a plurality of indicia, a respective one adjacent each of the samples and indicating a price for the respective sample. The prices are arranged in descending order from the upper left corner to the lower right corner. The plurality of indicia are permanently attached to the rigid substrate, such that the price of the sample located in the upper left corner is the highest and the price of the sample located in the lower right corner is the lowest.

The foregoing and additional aspects and implementations of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

FIG. 1 is a perspective view of a board assembly for shop-at-home services;

FIG. 1A is perspective exploded view of the two samples located in the upper-left corner of the board assembly shown in FIG. 1;

FIG. 1B is a perspective view of a board assembly for shop-at-home services;

FIG. 2 is a perspective view of a board assembly for shop-at-home services;

FIG. 3 is a perspective view of a folder containing several board assemblies for shop-at-home services;

FIG. 4 is a perspective view of an architectural folder including several board assemblies for shop-at-home services.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

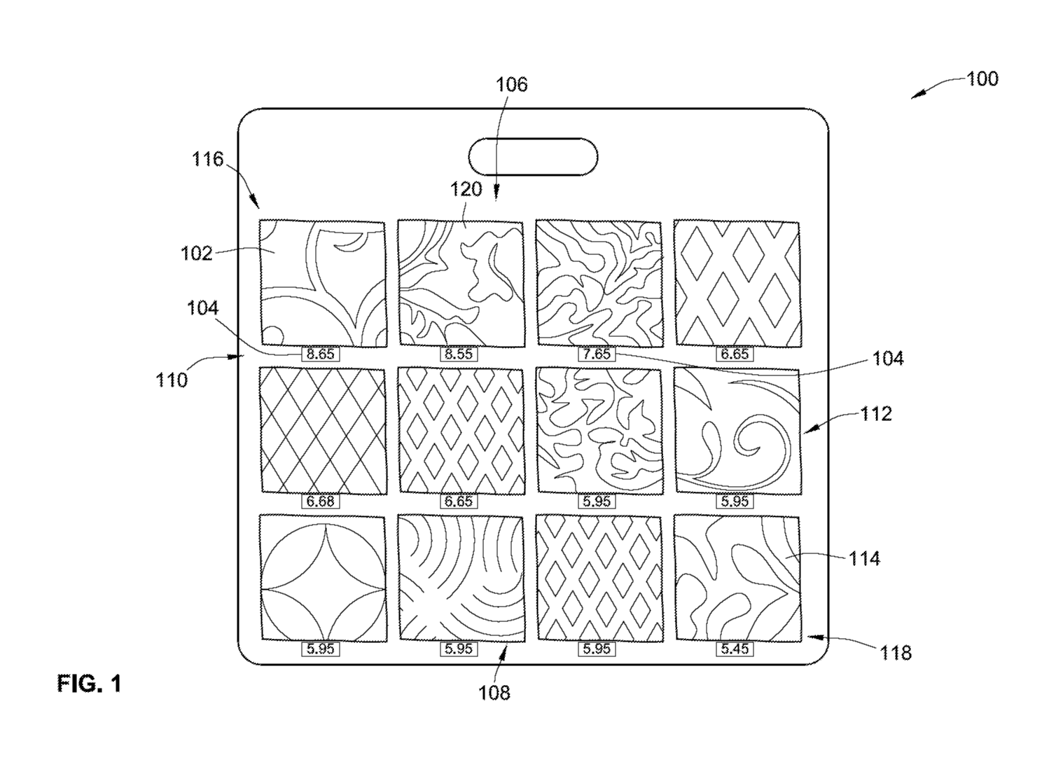

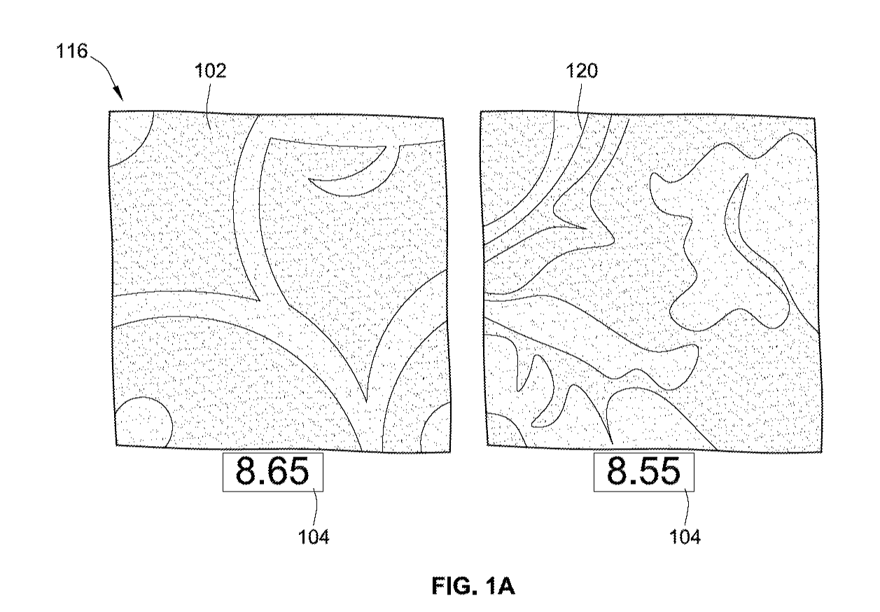

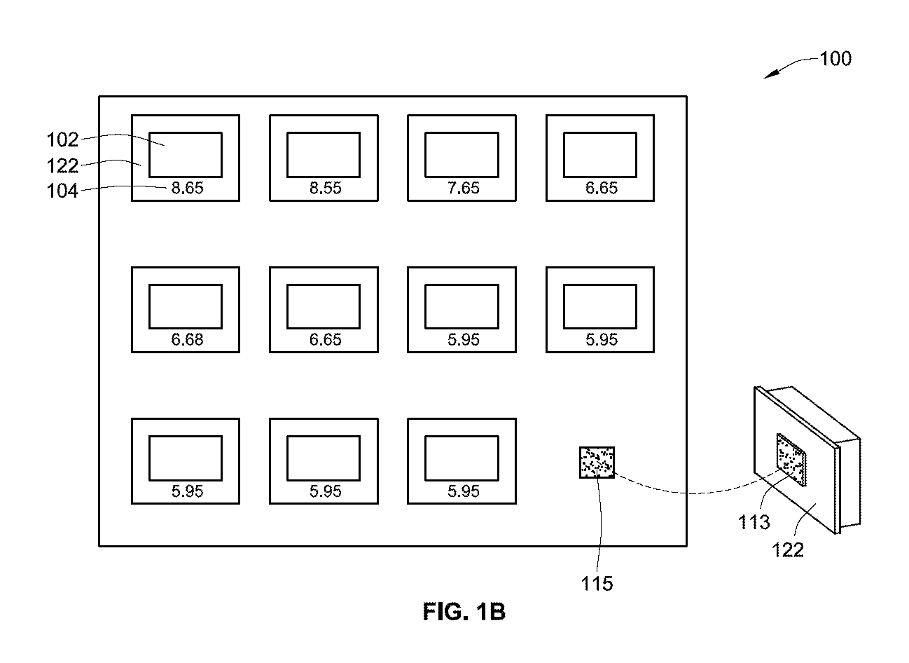

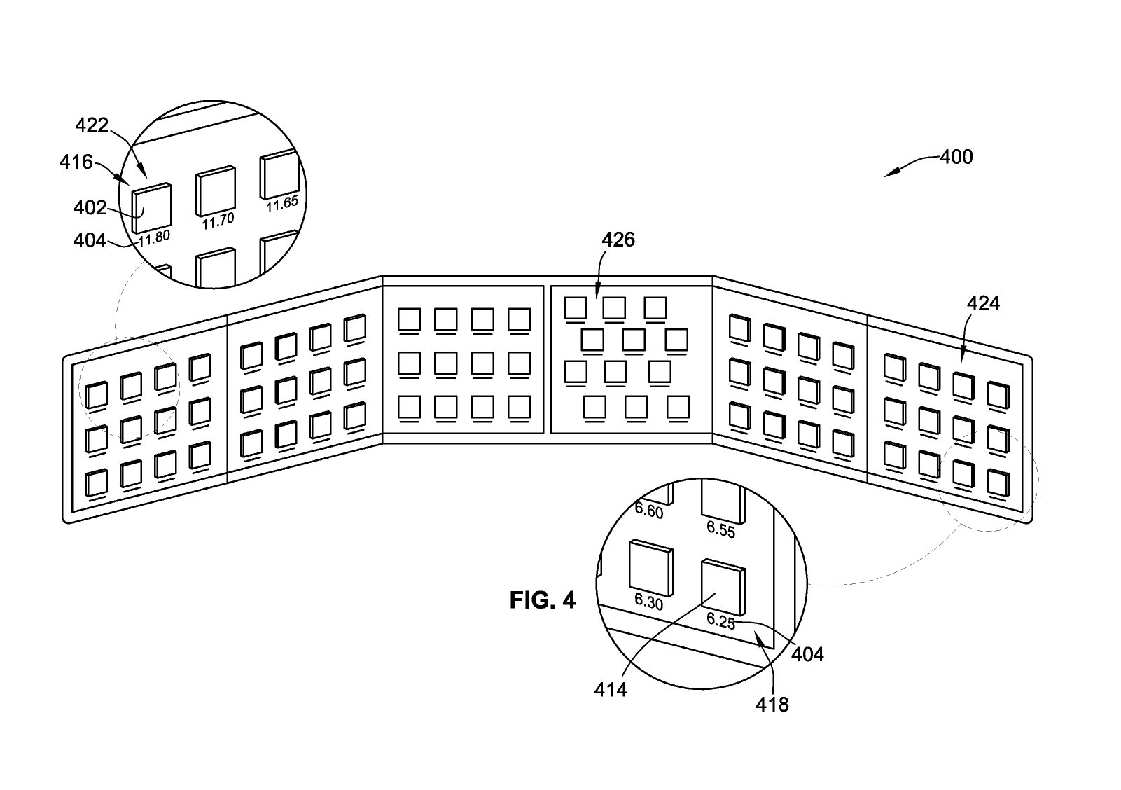

FIG. 1 is a perspective view of a board assembly 100 according to the present disclosure. The board assembly 100 may be made of any durable rigid or semi-rigid material, such as plastic, metal, wood, binder's board, and others. The board assembly 100 includes an array of samples 102 arranged thereon. The samples 102 may be any type of flooring samples, including carpet, hardwood, tile, linoleum, laminate, and others. The samples 102 may also be any samples that are generally used in the shop-at-home industry, including drapes, leather, textiles, and others. The samples 102 may be arranged on the board assembly 100 in a number of configurations. The samples 102 may be arranged, for example in a 3 rows×4 columns arrangement as shown in FIG. 1. Alternatively, the samples 402 may be arranged as shown on board 426 of FIG. 4. The samples 102 may be arranged in any suitable arrangement that may be used in shop-at-home catalogs.

The board assembly 100 includes a top section 106, a bottom section 108, a right section 110, and a left section 112. Each sample 102 includes a price indicium 104 associated therewith. The price indicia 104 are permanently attached to the board 100, or can be removable from the board 100 but have a visual impression of being permanently affixed to the board 100. The price indicia 104 may be attached to the board 100 by any suitable means. Sample 102 located in a top-left corner 116 has the highest price indicium 104 associated therewith as compared to all the samples arranged on the board 100. Thus, no other sample 102 has a higher price indicium 104 associated therewith than the sample 102 located in the top-left corner 116. Sample 114 located in a bottom-right corner 118 has a lowest price indicium 104 associated therewith out of all the samples 102 shown on the board 100. The prices here are in U.S. dollars, but of course any other currency can be used depending on geographic locale.

FIG. 1A is a perspective exploded view of the sample 102 located in the top-left corner 116 and the sample 120 located directly to the right of the sample 102 located in the top-left corner 116. Price indicium “8.65” is associated with the sample 102 located in the top-left corner 116 and price indicium “8.55” is associated with the sample 120. Alternatively, price indicia 104 for adjoining samples 102 located in the top-left corner 116 and sample 120 located directly to the right of it may be identical. Price indicia 104 decrease from left to right and from top to bottom. In an alternative embodiment, the cost to the shop-at-home services provider associated with the sample 102 located in the top-left corner 116 represents the highest cost to the shop-at-home services provider out of all the samples 102 located on the board 100. Similarly, in an alternative embodiment, the cost to the shop-at-home services provider associated with the sample 114 located in the bottom-right corner 118 represents the lowest cost to the shop-at-home services provider out of all the samples 102 located on the board 100. Thus, the samples 102 may be arranged on the board 100 in a descending order from the top-left corner 116 to the bottom-right corner 118 with respect to both the cost to the customer and to the shop-at-home service provider. Generally, purchasers tend to think that the items in a top-left corner 116 have the highest price and those in the lower-right corner have the lowest price, so their eyes and brains will naturally evaluate the relative quality and expense of the samples in the same manner that they are presented.

Referring now to FIG. 1B, in another aspect of the present disclosure, the samples 102 and the price indicia 104 associated therewith may be permanently attached to a substrate 122. The substrate 122 may be the same as or different from the material from which the substrate 100 is constructed. The substrate 122 may be constructed out of plastic, metal wood, book binder's material, or any other suitable material. The substrate 122 may be permanently attached to the board assembly 100 by any acceptable means. In another aspect, the substrate 122 may be removably attached to the board assembly 100 by any suitable means, including, but not limited to, a pair of magnets 115 and 113 and Velcro® fasteners 115 and 113.

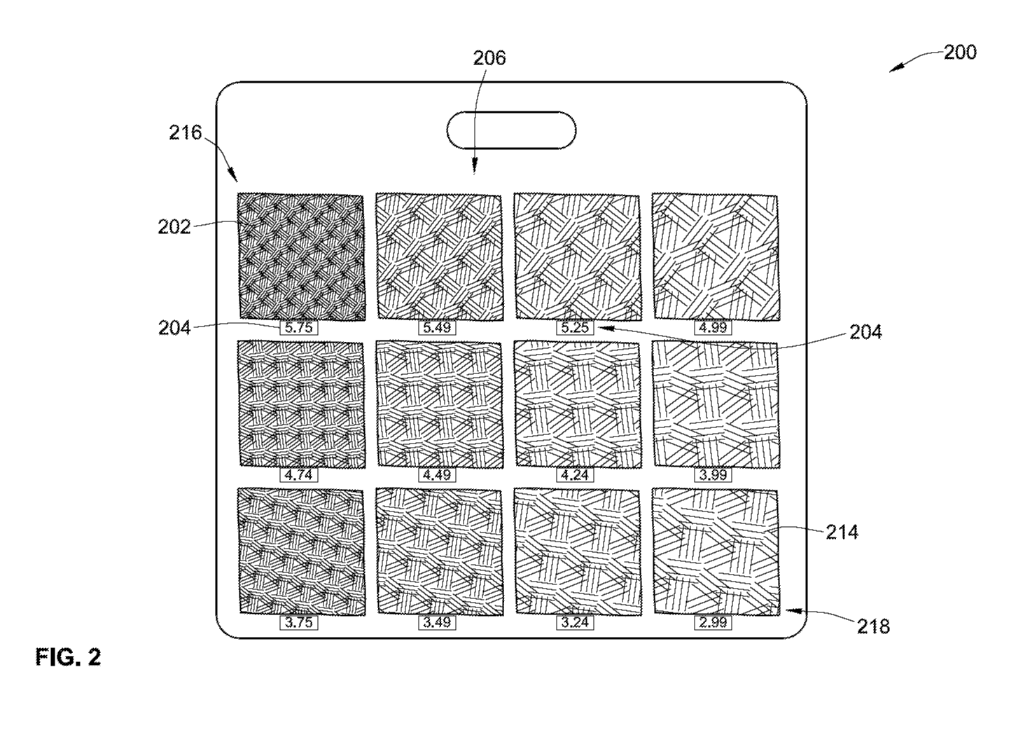

Referring now to FIG. 2, samples 202 arranged on the board assembly 200 may include samples of the same or similar styles. Table 1 below includes examples of different carpet companies and some carpet styles carried by those companies.

TABLE 1
Sample List of Carpet Companies and Styles

| CARPET COMPANY | STYLE |
|---|---|
| American Berber | Invincible |
| | Glen Hollow |
| Beaulieu | Baytown |
| | Elevations |
| Dixie | North Oaks |
| | Ristow |
| | Wishing Tree |
| Godfrey Hirst | Soho II |
| | Glen Abbey |
| Kraus | Castle Rock III |
| | Textra Plus III |
| | Woodbine |
| Lexmark | London |
| | Lexington |
| | Love Story |
| Mohawk | Casa Grande |
| | Serenity Beach |
| | American Dream |
| Royalty | Sheer Desire |
| | Sweet Dream |
| | Palace Square |
| Southwind | Capri |
| | Monte Cristo |
| | Waterford |
| Shaw | Casual Chic |
| | Ballerina |
| | Crystal Visions |
| | Del Mar |
| | XV640 |

As shown in Table 1 above, the Carpet Company Godfrey Hirst carries “Soho II” and “Glen Abbey” styles. Each style typically includes a variety of samples in different colors and of different quality, and, thus of different price. Thus, there may be “Soho II” style carpet that costs about $8 per square foot and there may be lower-priced “Soho II” style that costs about $5 per square foot. The board assembly 200 includes samples 202 that have similar styles or patterns, but different quality. The sample 202 located in the top-left corner 216 has the highest price indicium 204 associated therewith and the highest quality out all of the samples 202 located on the board 200. The sample 214 located in the bottom-right corner 218 has the lowest price indicium 204 associated therewith and the lowest quality for samples of that style as compared to all the other samples 202 arranged on the board 200.

Alternatively, a single board assembly may include only samples from the same manufacturer arranged thereon. The most expensive sample is located in the top-left corner and the least expensive sample is located in the bottom-right corner.

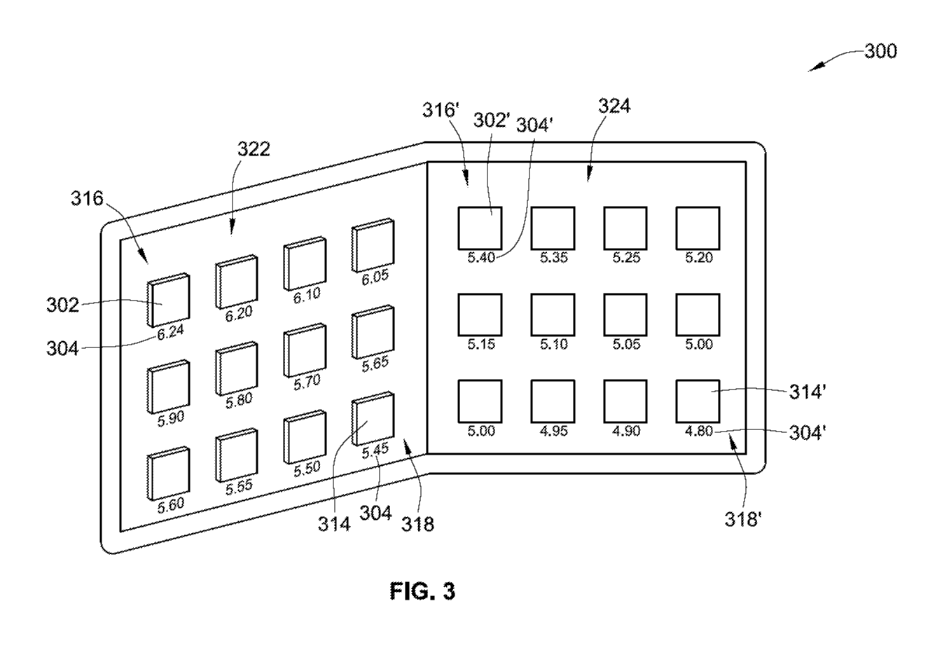

Referring now to FIG. 3, a folder 300 including a board assembly 322 and a board assembly 324 is shown. The folder 300 may contain 2 or more board assemblies 322 and 324. The sample 302 located in the top-left corner 316 has the highest price out of all the samples arranged on the board assembly 322. The sample 314 located in the lower-right corner 316 has the lowest price indicium 304 associated therewith out of all the samples 302 located on the board assembly 322. The board assemblies 322 and 324 may be arranged such that the price indicium associated with the sample 318 located in the lower-right corner 318 of the board assembly 322 is higher than or the same as the price indicium 304′ associated with the sample 302′ located in the top-left corner 316′ of the board assembly 324. The price indicium 304′ associated with the sample 314′ located in the lower-right corner 318′ of the board assembly 324 is the lowest price indicium 304′ present on board assembly 324.

FIG. 3 shows a folder 300 including two board assemblies 322 and 324. The folder 300 may include two or more board assemblies. For example, the folder 300 may be a binder including multiple pages of board assemblies. If the folder 300 includes multiple board assemblies, the sample located in the top-left corner of the board assembly located on the first page of the folder 300 may have the highest price indicium associated therewith as compared to all the other samples in the folder 300. The sample located in the bottom-right corner of the board assembly located on the last page of the folder 300 may have the lowest price indicium associated therewith as compared to all the other samples in the folder 300.

In another aspect of the present disclosure, the board assemblies 322 and 324 may be arranged such that the price indicium 304′ associated with the sample 302′ located in the top-left corner 316′ of the board assembly 324 is independent of the price indicium 304 associated with the sample 314 located in the lower-right corner 318 of the board assembly 322. For example, the folder may include one board assembly 322 including prices for the “North Oaks” style of carpet from Dixie a second board assembly 324 including prices for the “Ristow” style of carpet from Dixie. The prices for the highest-quality samples for both the “North Oaks” and the “Ristow” carpet styles may be about the same, for example, about $9 per square foot. Similarly, the prices for the lowest-quality samples for both styles may be about the same. Thus, the prices on the two boards 322 and 324 may be independent of each other.

In another aspect of the present disclosure, each board assembly 322, 324 includes samples of the same style, but of different quality. In such an arrangement, the price indicia associated with samples on one board assembly are independent of the price indicia associated with samples on another board assembly. In other words, the price indicium associated with the sample located in the top-left corner of one board is independent of the price indicium associated with any sample located on another board.

Referring now to FIG. 4, an architectural folder 400 including several board assemblies (e.g., 422, 424, 426) is shown. The several board assemblies are configured to fold onto each other. The price indicium 404 are arranged such that the price indicium 404 associated with the sample 402 located in the top-left corner 416 of the board assembly 422 is the highest price indicium 404 out of all the samples arranged in the architectural folder 400. The price indicium 404 associated with the sample 414 located in the bottom-right corner 418 of the board assembly 424 is the lowest price indicium 404 out of all the samples arranged in the folder 400.

While particular embodiments and applications of the present disclosure have been illustrated and described, it is to be understood that this disclosure is not limited to the precise construction and compositions disclosed herein and that various modifications, changes, and variations can be apparent from the foregoing descriptions without departing from the spirit and scope of the invention as defined in the appended claims.

1. A portable assembly for shop-at-home services, comprising:
a rigid substrate, having an upper left corner, an upper right corner, a lower left corner, and a lower right corner;
a plurality of flooring samples attached to respective individual substrates; and
a plurality of indicia, each one of the plurality of indicia being attached to a respective one of the individual substrates and indicating a price associated with a corresponding one of the plurality of flooring samples attached to the respective one of the individual substrates, the individual substrates being attached to the rigid substrate for selling associated flooring during a shop-at-home service such that the plurality of flooring samples are arranged in a descending price order from the upper left corner to the lower right corner such that the price of the flooring sample located closest to the upper left corner of the rigid substrate is associated with the indicia indicating the highest price out of the plurality of indicia and the flooring sample located closest to the lower right corner of the rigid substrate is associated with the indicia indicating the lowest priceout of the plurality of indicia.

2. The portable assembly of claim 1, wherein the plurality of flooring samples are grouped in an array of rows and columns.

3. The portable assembly of claim 1, wherein the individual substrates are removably attached to the rigid substrate.

4. The portable assembly of claim 1, wherein the flooring samples include at least one of carpet samples, hardwood samples, tile samples, and laminate samples.

5. The portable assembly of claim 1, wherein the rigid substrate comprises two or more sections which are configured to fold onto each other.

6. The portable assembly of claim 1, wherein the rigid substrate includes wood.

7. The portable assembly of claim 1, wherein the rigid substrate includes plastic.

8. The portable assembly of claim 1, wherein the plurality of flooring samples include twelve samples that are grouped into four columns and three rows.

9. The portable assembly of claim 1, comprising a plurality of rigid substrates organized in an architectural folder.

10. The portable assembly of claim 1, wherein the plurality of samples are all of the same or substantially similar style.

11. The portable assembly of claim 1, wherein the plurality of samples are all of the same or substantially similar price and/or quality category.

12. The portable assembly of claim 1, wherein the plurality of samples are all from a single manufacturer.

13. (canceled)

14. A portable assembly for shop-at-home services, comprising:
two rigid substrates arranged in a folder, each one of the two rigid substrates comprising an upper left corner and a lower right corner;
a plurality of flooring samples of the same style attached to respective individual substrates; and
a plurality of indicia, each one of the plurality of indicia being attached to a respective one of the individual substrates and indicating a price associated with a corresponding one of the plurality of flooring samples attached to the respective one of the individual substrates, the individual substrates being attached to the two rigid substrates for selling associated flooring during a shop-at-home service such that the plurality of flooring samples are arranged in a descending price order from the upper left corner of a first one of the two rigid substrates to the lower right corner of a second one of the two rigid substrates such that the price of the sample located in the upper left corner of the first one of the two rigid substrates is the highest out of the plurality of indicia and the price of the sample located in the lower right corner of the second one of the two rigid substrates is the lowest out of the plurality of indicia,
wherein the indicia are configured to provide assurance to a shop-at-home customer that the price associated with the samples is an actual price of the samples and does not vary from one shop-at-home customer to another.

15. The portable assembly of claim 14, wherein the style of the plurality of flooring samples arranged on the first one of the two rigid substrates is different from the style of the plurality of flooring samples arranged on the second one of the two substrates.

16-17. (canceled)

18. The portable assembly of claim 1, wherein each one of the plurality of indicia is attached to the respective one of the individual substrates in a manner that creates a visible impression that each of the plurality of indicia is permanently attached to the respective individual substrate.

19. The portable assembly of claim 3, wherein the individual substrates are removably attached to the rigid substrate using pairs of magnets or using Velcro® fasteners.

20. The portable assembly of claim 14, wherein the individual substrates are removably attached to the two rigid substrates.

21. The portable assembly of claim 20, wherein the individual substrates are removably attached to the two rigid substrates using pairs of magnets or using Velcro® fasteners.
